(19) United States
(12) Patent Application Publication
(10) Pub. No.: US 2022/0230028 A1
(43) Pub. Date: Jul. 21, 2022

(54) DETERMINATION METHOD, NON-TRANSITORY COMPUTER-READABLE STORAGE MEDIUM, AND INFORMATION PROCESSING DEVICE

(71) Applicant: FUJITSU LIMITED, Kawasaki-shi (JP)

(72) Inventor: Yasuto Yokota, Kawasaki (JP)

(73) Assignee: FUJITSU LIMITED, Kawasaki-shi (JP)

(21) Appl. No.: 17/715,687

(22) Filed: Apr. 7, 2022

Related U.S. Application Data
(63) Continuation of application No. PCT/JP2019/041793, filed on Oct. 24, 2019.

(51) Int. Cl. G06K 9/62; G06N 20/00

(52) U.S. Cl. CPC G06K 9/6262; G06N 20/00; G06K 9/623

(57) ABSTRACT

A determination method performed by a computer, the determination method includes acquiring a first output result when data generated under second environment different from a first environment that is a training environment is input to a trained model, acquiring a second output result when the data is input to a detection model that detects decrease in a correct answer rate of a trained model when the trained model is converted into the second environment, and determining whether or not to retrain the trained model when the trained model is converted into the second environment based on the first output result and the second output result.

### CROSS-REFERENCE TO RELATED APPLICATION

This application is a continuation application of International Application PCT/JP2019/041793 filed on Oct. 24, 2019 and designated the U.S., the entire contents of which are incorporated herein by reference.

### FIELD

The embodiments discussed herein are related to a determination method, a determination program, and an information processing device.

### BACKGROUND

A machine learning model (hereinafter, may be simply referred to as “model”) has been increasingly introduced into an information system used in companies or the like, for data determination and classification functions, or the like. Because the machine learning model performs determination and classification as in learned teacher data when the system is developed, if a tendency (data distribution) of input data changes during a system operation, accuracy of the machine learning model deteriorates.

Generally, in order to detect the model accuracy deterioration during the system operation, a method is used for periodically and manually calculating a correct answer rate by confirming whether or not an output result of the model is correct or wrong by humans and detecting accuracy deterioration from decrease in the correct answer rate.

In recent years, as a technique for automatically detecting the accuracy deterioration of the machine learning model during the system operation, a T² statistics amount (Hotelling's T-square) has been known. For example, main components of an input data group and a normal data (training data) group are analyzed, and a T² statistics amount of input data that is a sum of squares of distances from an origin to respective standardized main components is calculated. Then, a change in a ratio of abnormal value data is detected on the basis of a distribution of the T² statistics amount of the input data group, and the accuracy deterioration of the model is automatically detected.

A. Shabbak and H. Midi, “An Improvement of the Hotelling T² Statistic in Monitoring Multivariate Quality Characteristics”, Mathematical Problems in Engineering, pp. 1 to 15, 2012 is disclosed as related art.

### SUMMARY

According to an aspect of the embodiments, a determination method performed by a computer, the determination method includes: acquiring a first output result when data generated under second environment different from a first environment that is a training environment is input to a trained model; acquiring a second output result when the data is input to a detection model that detects decrease in a correct answer rate of a trained model when the trained model is converted into the second environment; and determining whether or not to retrain the trained model when the trained model is converted into the second environment based on the first output result and the second output result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an introduction determination device according to a first embodiment;

FIG. 2 is a diagram for explaining accuracy deterioration;

FIG. 3 is a diagram for explaining an inspector model according to the first embodiment;

FIG. 4 is a functional block diagram illustrating a functional structure of the introduction determination device according to the first embodiment;

FIG. 5 is a diagram illustrating an example of information stored in a development environment data database (DB);

FIG. 6 is a diagram for explaining a specific example of teacher data;

FIG. 7 is a diagram illustrating an example of information stored in an introduction destination data DB;

FIG. 8 is a diagram illustrating a relationship between the number of pieces of training data and an applicable range;

FIG. 9 is a diagram for explaining detection of accuracy deterioration;

FIG. 10A is diagram for explaining introduction determination according to a matching rate;

FIG. 10B is diagram for explaining introduction determination according to a matching rate;

FIG. 10C is diagram for explaining introduction determination according to a matching rate;

FIG. 11 is a flowchart illustrating a flow of processing;

FIG. 12 is a diagram for explaining a specific example whether or not to perform introduction;

FIG. 13 is a diagram for explaining a method for generating a machine learning model according to a second embodiment; and

FIG. 14 is a diagram for explaining a hardware structure example.

### DESCRIPTION OF EMBODIMENTS

In the related art, there are many cases where a development environment of a machine learning model and an introduction environment (production environment) where the machine learning model is introduced do not necessarily match and feature amounts and qualities of input data differ. For example, when image data is used, because brightness, camera installation positions, camera performances, or the like differ, resolutions of image data to be captured or the like also differ.

Generally, because the machine learning model performs determination and classification according to learned teacher data under the development environment at the time of development, it is considered that performance is decreased due to a difference between tendencies (data distribution) of the teacher data under the development environment and the input data under the production environment. At present, at the time of the introduction into the production environment, by manually confirming whether or not an output result of a model is correct or wrong by humans, a correct answer rate is calculated, a model performance is inspected, and it is determined whether or not to perform introduction.

In one aspect, an object is to provide a determination method, a determination program, and an information processing device that can automatically inspect whether or not a learned machine learning model is introduced into a production environment.

Hereinafter, embodiments of a determination method, a determination program, and an information processing device according to the present disclosure will be described in detail with reference to the drawings. Note that, the embodiments do not limit the present disclosure. Furthermore, each of the embodiments may be appropriately combined within a range without inconsistency.

### First Embodiment

### Explanation of Introduction Determination Device

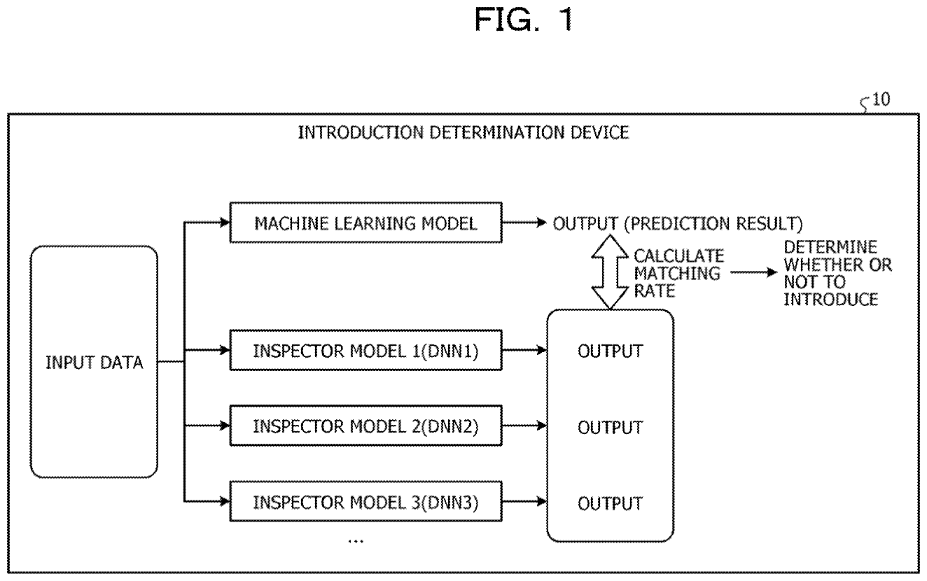

FIG. 1 is a diagram for explaining an introduction determination device 10 according to a first embodiment. The introduction determination device 10 illustrated in FIG. 1 is an example of a computer device that determines (classify) input data using a learned machine learning model (trained model) (hereinafter, may be simply referred to as “model”) and monitors accuracy of the machine learning model and detects accuracy deterioration.

For example, the machine learning model is an image classifier that is learned using teacher data with an explanatory variable as image data and an objective variable as a clothing name at the time of learning and outputs a determination result such as “shirt” when the image data is input as the input data at the time of an operation. That is, for example, the machine learning model is an example of an image classifier that classifies high-dimensional data or performs multi-class classification.

Here, because the machine learning model learned through machine learning, deep learning, or the like is learned based on teacher data in which training data and labeling are combined, the machine learning model functions only in a range included in the teacher data. For example, when teacher data imaged in a development environment is used, learning is performed in a state where a feature amount under the development environment is included (state of which distribution of input data is different from production environment). Therefore, when the learned machine learning model learned under the development environment is introduced into the production environment different from the development environment, the distribution of the input data differs. Therefore, there is a case where accuracy deteriorates under the production environment and it is not possible to exhibit a performance that is about the same as that under the development environment.

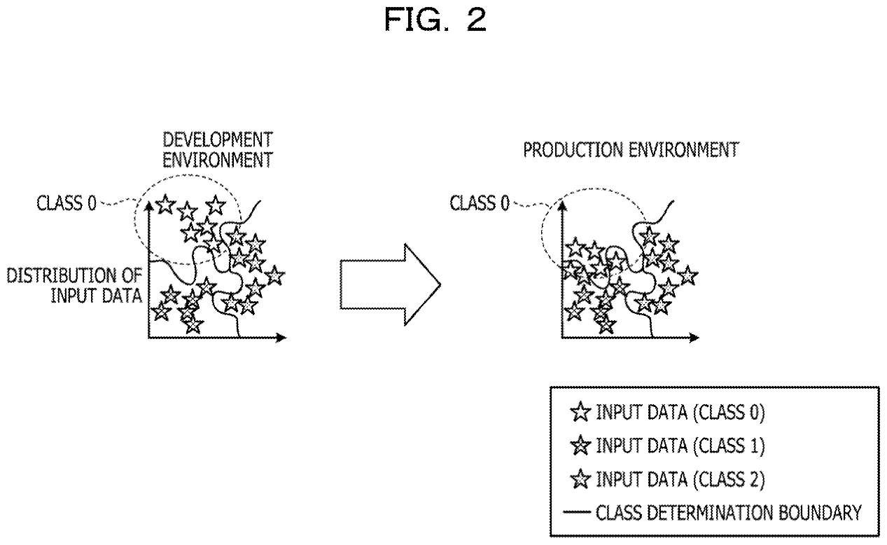

FIG. 2 is a diagram for explaining the accuracy deterioration. FIG. 2 illustrates information that is organized by excluding unnecessary data of the input data and illustrates a feature amount space in which the machine learning model classifies the input data that has been input. FIG. 2 illustrates a feature amount space classified into a class 0, a class 1, and a class 2.

As illustrated in FIG. 2, under the development environment, when data is input to the machine learning model, all pieces of input data are at normal positions and are classified inside of a determination boundary of each class. Therefore, reliability of an output result of the machine learning model is high, and high accuracy can be maintained. However, under the production environment, there is a case where a distribution of input data of a class 0 is different from that under the development environment. For example, input data that is difficult to be classified into the class 0 according to a feature amount of the class 0 that has been learned is input. In this case, under the production environment, the input data of the class 0 crosses the determination boundary, and a correct answer rate of the machine learning model decreases. For example, the feature amount of the input data to be classified into the class 0 is different from that under the development environment.

In this way, there is a case where the distribution of the input data changes from that at the time of learning when the introduction from the development environment into the production environment is performed, as a result, the correct answer rate of the machine learning model decreases, and accuracy deterioration of the machine learning model occurs.

Therefore, as illustrated in FIG. 1, the introduction determination device 10 according to the first embodiment uses at least one inspector model (monitor, may be simply referred to as “inspector” below) that solves a problem similar to the machine learning model to be monitored and is generated using a deep neural network (DNN). Specifically, for example, before introducing the machine learning model into the production environment, the introduction determination device 10 calculates a matching rate between an output of the machine learning model and an output of each inspector model for the data under the production environment for each output class of the machine learning model. In this way, the introduction determination device 10 according to the first embodiment determines whether or not the machine learning model can be introduced.

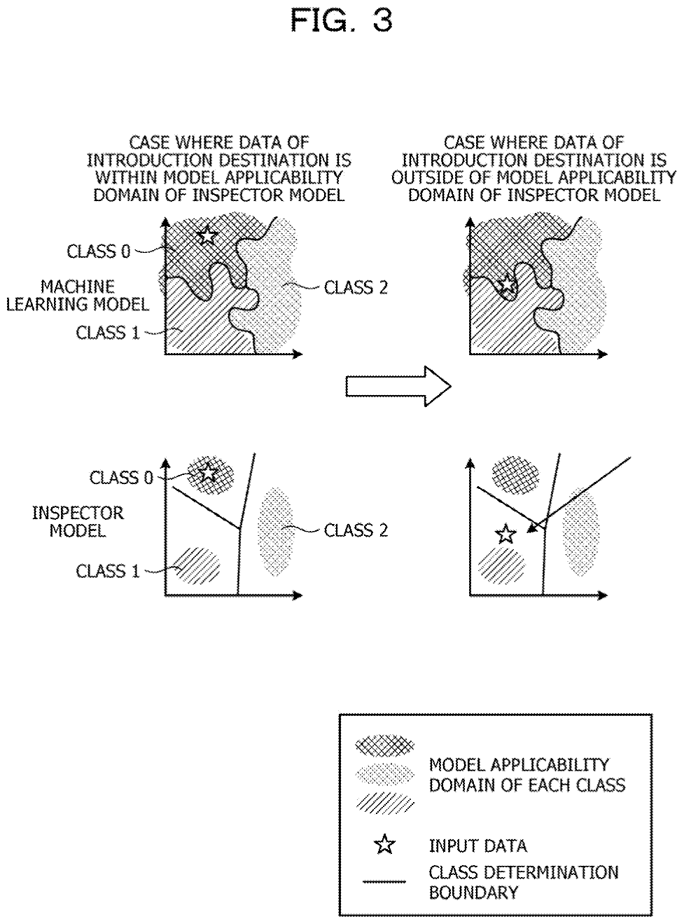

Here, the inspector model will be described. FIG. 3 is a diagram for explaining the inspector model according to the first embodiment. The inspector model is an example of a detection model that is generated under conditions (different model applicability domain) different from the machine learning model. That is, for example, the inspector model is generated so that each region (each feature amount) determined by the inspector model as the class 0, the class 1, or the class 2 is narrower than each region determined by the machine learning model as the class 0, the class 1, or the class 2.

This is because, as the model applicability domain is narrower, a slight change in the input data more sensitively changes the output. Therefore, by narrowing the model applicability domain of the inspector model than the machine learning model to be monitored, an output value of the inspector model fluctuates due to a small change in the input data, and a change in data tendency can be measured according to the matching rate with the output value of the machine learning model.

Specifically, for example, as illustrated in FIG. 3, when input data of an introduction destination (production environment) is within a range of a model applicability domain of the inspector model, the machine learning model determines the corresponding input data as the class 0, and the inspector model also determines the corresponding input data as the class 0. That is, for example, both models are within the model applicability domain of the class 0, and the output values constantly match. Therefore, the matching rate does not decrease.

On the other hand, when the input data of the introduction destination (production environment) is outside the range of the model applicability domain of the inspector model, although the machine learning model determines the corresponding input data as the class 0, the inspector model does not necessarily determine the corresponding input data as the class 0 because the corresponding input data is outside the model applicability range of each class. That is, for example, because the output values do not necessarily match, the matching rate decreases.

In this way, the introduction determination device 10 according to the first embodiment inputs the input data under the production environment into each of the machine learning model of which development is in progress or development has been completed and the inspector model that is learned to have a model applicability domain narrower than a model applicability domain of the machine learning model and acquires an output result. Then, the introduction determination device 10 can collect a change in the accuracy when the machine learning model is introduced into the production environment in advance according to the matching rate of the output results.

### Functional Structure of Introduction Determination Device

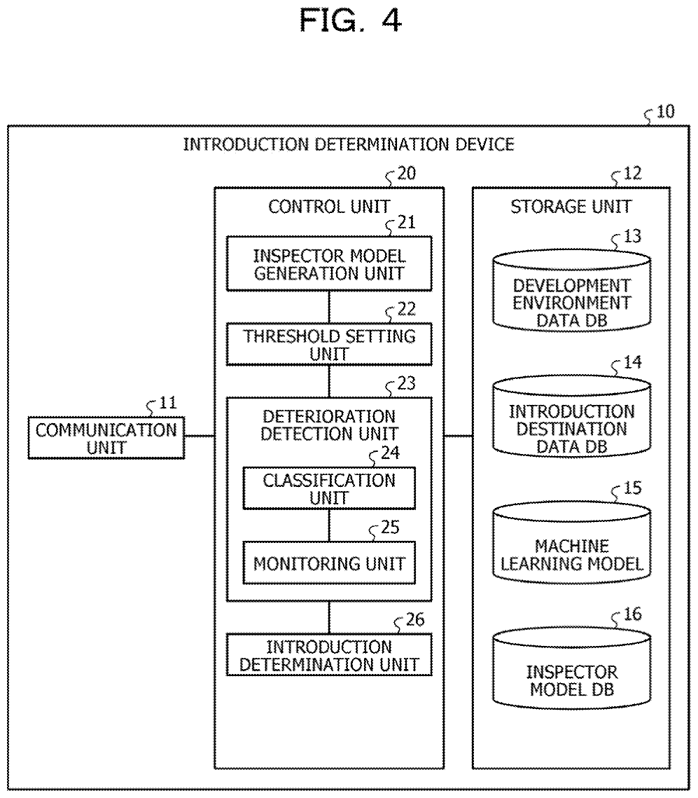

FIG. 4 is a functional block diagram illustrating a functional structure of the introduction determination device 10 according to the first embodiment. As illustrated in FIG. 4, the introduction determination device 10 includes a communication unit 11, a storage unit 12, and a control unit 20.

The communication unit 11 is a processing unit that controls communication with another device, and is, for example, a communication interface or the like. For example, the communication unit 11 receives various instructions from an administrator's terminal or the like. Furthermore, the communication unit 11 receives input data to be determined from various terminals.

The storage unit 12 is an example of a storage device that stores data and a program or the like executed by the control unit 20, and is, for example, a memory, a hard disk, or the like. The storage unit 12 stores a development environment data DB 13, an introduction destination data DB 14, a machine learning model 15, and an inspector model DB 16.

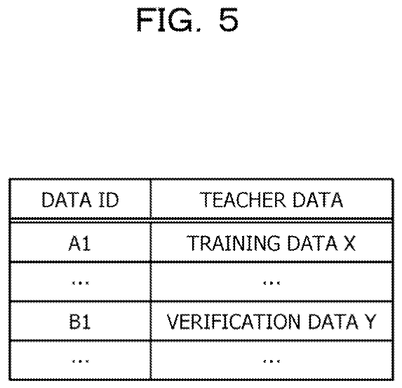

The development environment data DB 13 is a database that stores teacher data under the development environment used to learn the machine learning model that is teacher data used to learn the inspector model. FIG. 5 is a diagram illustrating an example of information stored in the development environment data DB 13. As illustrated in FIG. 5, the development environment data DB 13 stores a data ID and teacher data in association with each other.

The stored data ID here is an identifier for identifying teacher data. The teacher data is training data used for learning or verification data used for verification at the time of learning. In the example in FIG. 5, training data X of which a data ID is “μl” and verification data Y of which a data ID is “Bl” are illustrated. Note that, the training data and the verification data are data in which image data that is an explanatory variable is associated with correct answer information (label) that is an objective variable.

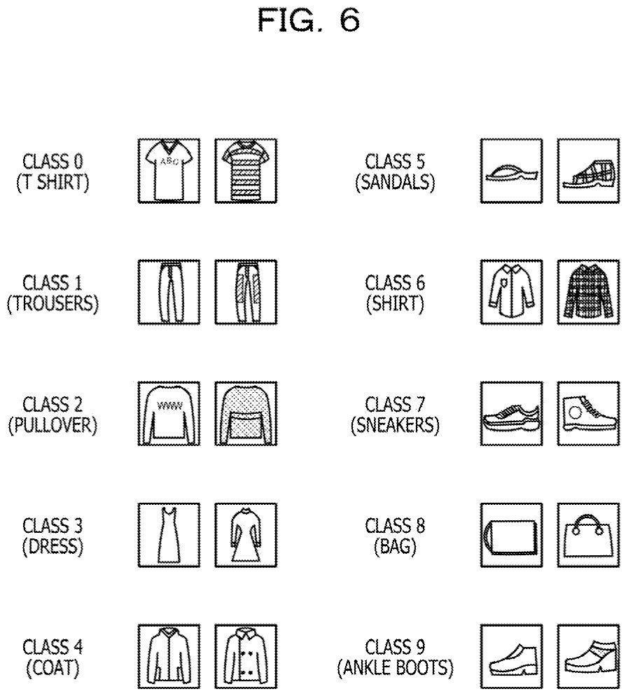

An example of image data used for the teacher data will be described. FIG. 6 is a diagram for explaining a specific example of the teacher data. As illustrated in FIG. 6, the specific example of the teacher data uses image data of each of a T shirt of which a label is a class 0, trousers of which a label is a class 1, a pullover of which a label is a class 2, a dress of which a label is a class 3, and a coat of which a label is a class 4. Furthermore, image data of each of sandals of which a label is a class 5, a shirt of which a label is a class 6, sneakers of which a label is a class 7, a bag of which a label is a class 8, and ankle boots of which a label is a class 9 is used.

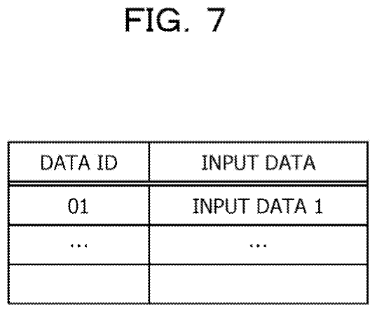

The introduction destination data DB 14 is a database that stores data acquired or collected in the introduction destination (production environment) that is a destination where the machine learning model 15 is introduced. Specifically, for example, the introduction destination data DB 14 stores image data that is assumed to be input to the machine learning model or image data to be image-classified. FIG. 7 is a diagram illustrating an example of information stored in the introduction destination data DB 14. As illustrated in FIG. 7, the introduction destination data DB 14 stores a data ID and input data in association with each other.

The stored data ID here is an identifier for identifying input data. The input data is image data to be classified that is assumed to be determined (predicted) by the machine learning model 15. In the example in FIG. 7, input data 1 of which a data ID is “01” is illustrated. It is not necessary to store the input data in advance, and the input data may be transmitted as a data stream from another terminal.

The machine learning model 15 is a learned machine learning model and is a model to be evaluated by the introduction determination device 10. Note that the machine learning model 15 of a neural network, a support vector machine, or the like to which a learned parameter is set can be stored, and the learned machine learning model 15 may also store a learned parameter or the like that can be constructed.

The inspector model DB 16 is a database that stores information regarding at least one inspector model used to detect accuracy deterioration. For example, the inspector model DB 16 stores parameters used to respectively construct five inspector models that are various parameters of the DNN generated (optimized) through machine learning by the control unit 20 to be described later. Note that, the inspector model DB 16 can store a learned parameter and can store an inspector model (DNN) to which the learned parameter is set.

The control unit 20 is a processing unit that controls the entire introduction determination device 10 and is, for example, a processor or the like. The control unit 20 includes an inspector model generation unit 21, a threshold setting unit 22, a deterioration detection unit 23, and an introduction determination unit 26. Note that, the inspector model generation unit 21, the threshold setting unit 22, the deterioration detection unit 23, and the introduction determination unit 26 are examples of an electronic circuit included in a processor, examples of a process executed by a processor, or the like.

The inspector model generation unit 21 is a processing unit that generates the inspector model that is an example of a monitor or a detection model that detects the accuracy deterioration of the machine learning model 15. Specifically, for example, the inspector model generation unit 21 generates a plurality of inspector models, of which model applicability ranges are different from each other, through deep learning using the teacher data, stored in the development environment data DB 13, used to learn the machine learning model 15. Then, the inspector model generation unit 21 stores various parameters used to construct the respective inspector models (each DNN), obtained through deep learning, having different model applicability ranges in the inspector model DB 16.

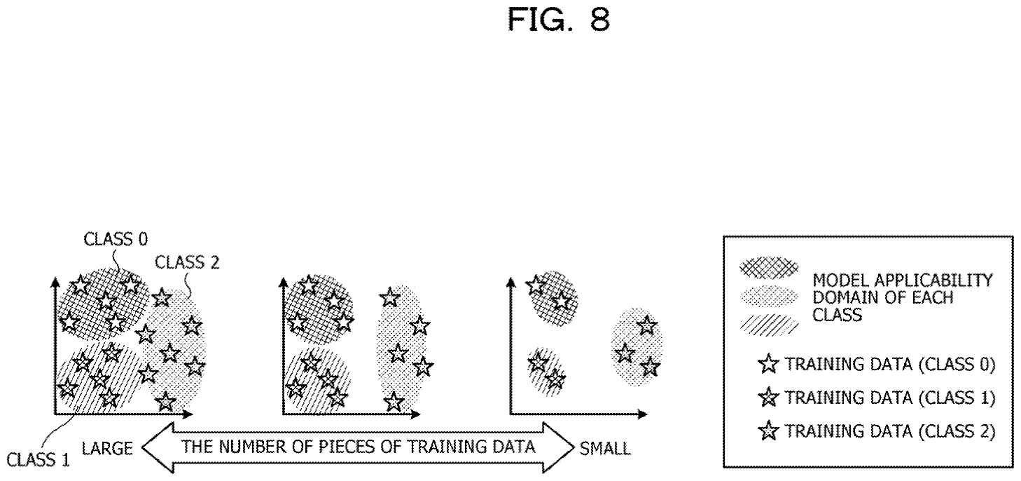

For example, by controlling the number of pieces of training data, the inspector model generation unit 21 generates the plurality of inspector models having the different applicable ranges. FIG. 8 is a diagram illustrating a relationship between the number of pieces of training data and an applicable range. FIG. 8 illustrates a feature amount space of classification into three classes including a class 0 to a class 2.

As illustrated in FIG. 8, generally, as the number of pieces of training data increases, more feature amounts are learned. Therefore, more comprehensive learning is performed, and a model having a wider model applicability range is generated. On the other hand, as the number of pieces of training data decreases, the number of feature amounts of the teacher data to be learned is smaller. Therefore, a covered range (feature amount) is limited, and a model having a narrow model applicability range is generated.

Therefore, the inspector model generation unit 21 generates a plurality of inspector models by setting the number of times of training to be the same and changing the number of pieces of training data. For example, a case will be considered where five inspector models are generated in a state where the machine learning model 15 is learned with the number of times of training (100 epochs) and the number of pieces of training data (1000 pieces per class). In this case, the inspector model generation unit 21 determines the number of pieces of training data of an inspector model 1 as “500 pieces per class”, the number of pieces of training data of an inspector model 2 as “400 pieces per class”, the number of pieces of training data of an inspector model 3 as “300 pieces per class”, the number of pieces of training data of an inspector model 4 as “200 pieces per class”, and the number of pieces of training data of an inspector model 5 as “100 pieces per class”, randomly selects teacher data from the development environment data DB 13, and learns each piece of the teacher data with 100 epochs.

Thereafter, the inspector model generation unit 21 stores various parameters of each of the learned inspector models 1 to 5 in the inspector model DB 16. In this way, the inspector model generation unit 21 can generate the five inspector models that have model applicability ranges narrower than the applicable range of the machine learning model 15 and are different from each other.

Note that, the inspector model generation unit 21 can learn each inspector model using a method such as error back propagation and can adopt another method. For example, the inspector model generation unit 21 learns the inspector model (DNN) by updating the parameter of the DNN so as to reduce an error between an output result obtained by inputting the training data into the inspector model and a label of the input training data.

Returning to FIG. 4, the threshold setting unit 22 sets a threshold used to determine whether or not the machine learning model 15 is introduced into the production environment that is a threshold used to determine a matching rate. For example, the threshold setting unit 22 reads the machine learning model 15 from the storage unit 12 and reads various parameters from the inspector model DB 16 so as to construct the learned five inspector models. Then, the threshold setting unit 22 reads each piece of verification data under the development environment stored in the development environment data DB 13, inputs the read data into the machine learning model 15 and each inspector model, and acquires a distribution result to the model applicability domain on the basis of each output result (classification result).

Thereafter, the threshold setting unit 22 calculates a matching rate between the classes of the machine learning model 15 and the inspector model 1, a matching rate between the classes of the machine learning model 15 and the inspector model 2, a matching rate between the classes of the machine learning model 15 and the inspector model 3, a matching rate between the classes of the machine learning model 15 and the inspector model 4, and a matching rate between the classes of the machine learning model 15 and the inspector model 5, for the verification data.

Then, the threshold setting unit 22 sets a threshold using each matching rate. For example, the threshold setting unit 22 displays each matching rate on a display or the like and accepts setting of the threshold from a user. Furthermore, the threshold setting unit 22 can optionally select and set any one of an average value of the matching rates, a maximum value of the matching rates, a minimum value of the matching rates, or the like according to a deterioration state that the user requests to detect.

Returning to FIG. 4, the deterioration detection unit 23 is a processing unit that includes a classification unit 24 and a monitoring unit 25, compares an output result of the machine learning model 15 and an output result of each inspector model for the input data under the introduction environment, and detects accuracy deterioration of the machine learning model 15.

The classification unit 24 is a processing unit that inputs the input data stored in the introduction destination data DB 14 to each of the machine learning model 15 and each inspector model and acquires each output result (classification result). For example, the classification unit 24 acquires the parameter of each inspector model from the inspector model DB 16 and constructs each inspector model when learning of each inspector model is completed and executes the machine learning model 15.

Then, the classification unit 24 inputs the input data of the introduction destination to the machine learning model 15 and acquires the output result, and inputs the input data of the corresponding introduction destination into each of the five inspector models from the inspector model 1 (DNN 1) to the inspector model 5 (DNN 5) and acquires each output result. Thereafter, the classification unit 24 stores the input data of the introduction destination and each output result in the storage unit 12 in association with each other and outputs the stored data and result to the monitoring unit 25.

The monitoring unit 25 is a processing unit that monitors accuracy deterioration of the machine learning model 15 using the output result of each inspector model. Specifically, for example, the monitoring unit 25 measures a change in a distribution of a matching rate between the output of the machine learning model 15 and the output of the inspector model for each class on the basis of the processing result by the classification unit 24. For example, the monitoring unit 25 calculates a matching rate between the output result of the machine learning model 15 and the output result of each inspector model for each input data, and when the matching rate decreases, the monitoring unit 25 detects accuracy deterioration of the machine learning model 15. Note that, the monitoring unit 25 outputs the detection result to the introduction determination unit 26.

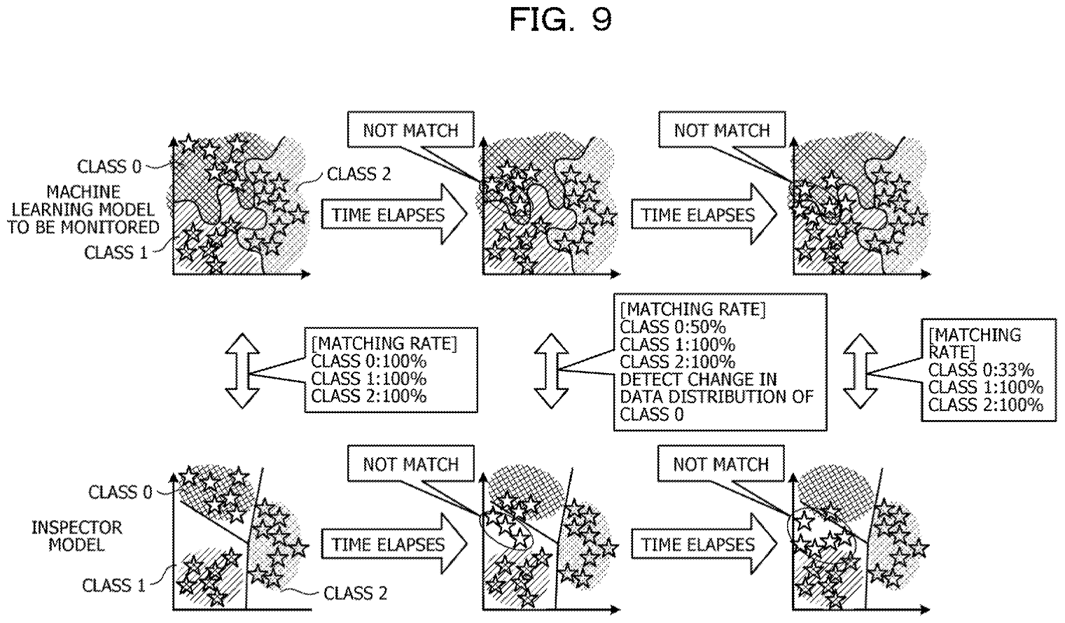

FIG. 9 is a diagram for explaining the detection of the accuracy deterioration. FIG. 9 illustrates an output result of the machine learning model 15 to be monitored and an output result of the inspector model for the input data of the introduction destination. Here, for easy explanation, using one inspector model as an example, a probability that the output of the machine learning model 15 to be monitored matches the output of the inspector model will be described using a data distribution to the model applicability domain in the feature amount space.

As illustrated in FIG. 9, the monitoring unit 25 acquires that six pieces of input data belongs to a model applicability domain of the class 0, six pieces of input data belongs to a model applicability domain of the class 1, and eight pieces of input data belongs to a model applicability domain of the class 2 from the machine learning model 15 to be monitored at the time of starting the operation. On the other hand, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate as 100% because the matching rates of each class of the machine learning model 15 and the inspector model match. At this timing, each of the classification results matches.

As the time elapses, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that three pieces of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate of the class 0 as 50% (( 3/6)×100) and calculates matching rates of the classes 1 and 2 as 100%. In other words, for example, a change in data distribution of the class 0 is detected. At this timing, the inspector model is in a state where the three pieces of input data that is not classified into the class 0 is not necessarily classified into the class 0.

As the time further elapses, the monitoring unit 25 acquires that three pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that one piece of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate of the class 0 as 33% ((⅓)×100) and calculates matching rates of the classes 1 and 2 as 100%. In other words, for example, it is determined that the data distribution of the class 0 is changed. A state at this timing is where the machine learning model 15 does not classify input data to be classified into the class 0 into the class 0, and the inspector model does not necessarily classify five pieces of input data, which has not been classified into the class 0, into the class 0.

In this way, the monitoring unit 25 calculates a matching rate when the input data of the introduction destination (production environment) is input to each of the machine learning model 15 developed using the teacher data under the development environment and each inspector model generated using the teacher data under the development environment. Then, the monitoring unit 25 periodically calculates the matching rate and outputs the matching rate to the introduction determination unit 26.

The introduction determination unit 26 is a processing unit that determines whether or not the machine learning model 15 is introduced into the production environment based on the matching rate calculated by the monitoring unit 25. Specifically, for example, the introduction determination unit 26 calculates an average of the matching rate for each class for each inspector model of which the matching rate is calculated for each class and calculates the matching rate of each inspector model. Then, when equal to or more than a predetermined number of inspector models, of which the matching rate is less than the threshold, among the inspector models exist, the introduction determination unit 26 determines that occurrence of accuracy deterioration can be predicted when the machine learning model 15 is introduced into the production environment, determines that it is not possible to introduce the machine learning model 15, and determines that the machine learning model 15 needs to be relearned.

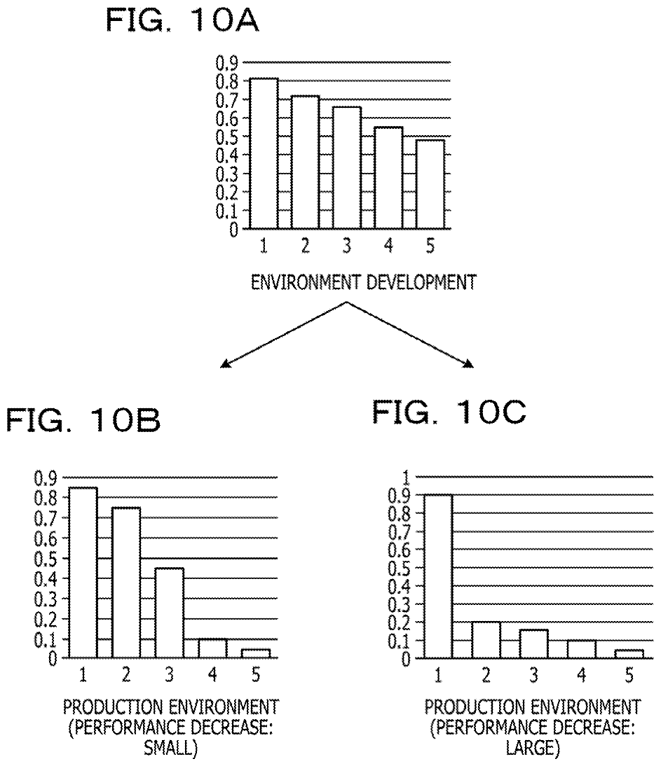

FIGS. 10A to 10C are diagrams for explaining introduction determination according to a matching rate. In FIGS. 10A to 10C, the horizontal axis indicates each inspector model, and the vertical axis indicates a matching rate (matched rate) of each inspector model and indicates a change in the matching rates of each of the five inspector models and the machine learning model 15. Here, description will be made as setting a threshold of the matching rate to be 0.6 (60%). Furthermore, regarding the sizes of the model applicability domains of the inspector models 1 to 5, the size of the model applicability domain of the inspector model 1 is the widest, and that of the inspector model 5 is the narrowest.

As illustrated in FIG. 10A, because the model applicability ranges are gradually narrowed from the inspector model 1 to the inspector model 5, a matching rate for the verification data under the development environment of the inspector model 1 is the highest, and that of the inspector model 5 is the lowest. In such a state, the introduction determination unit 26 inputs data of the introduction destination (production environment) to the machine learning model 15 and each inspector model, and perform introduction determination based on each matching rate.

For example, as illustrated in FIG. 10B, when the matching rates of the inspector models 1 and 2 are equal to or more than the threshold and the matching rates of the inspector models from 3 to 5 are less than the threshold, the introduction determination unit 26 determines that the introduction can be performed. Specifically, for example, because the number of inspector models of which the matching rate is equal or more than the threshold is equal to or more than a prescribed number (for example, two), the introduction determination unit 26 determines that performance deterioration when the machine learning model 15 is introduced into the production environment is small.

Furthermore, as illustrated in FIG. 10C, when the matching rate of the inspector model 1 is equal to or more than the threshold and the matching rates of the inspector models 2 to 5 are less than the threshold, the introduction determination unit 26 determines that it is not possible to perform introduction. Specifically, for example, because the number of inspector models of which the matching rate is equal or more than the threshold is less than the prescribed number (for example, two), the introduction determination unit 26 determines that performance deterioration when the machine learning model 15 is introduced into the production environment is large.

Furthermore, the introduction determination unit 26 can acquire the matching rate of each inspector model for each class and determine a policy for learning the machine learning model 15. For example, the introduction determination unit 26 compares the matching rates of the respective inspector models as in FIGS. 10A to 10C for each of the class 0 to the class 2. Then, it is assumed that the introduction determination unit 26 specify that the number of inspector models of which the matching rate of the class 0 is equal to or more than the threshold is three, the number of inspector models of which the matching rate of the class 1 is equal to or more than the threshold is four, and the number of inspector models of which the matching rate of the class 2 is equal to or more than the threshold is one.

In this case, the introduction determination unit 26 can output a message or the like that prompts to relearn the machine learning model 15 on a display or the like, for the class 2. As a result, a user can generate new teacher data by adding a noise or the like to teacher data used for learning, as the teacher data of the class 2 and relearn the machine learning model 15.

Furthermore, the introduction determination unit 26 can automatically relearn the machine learning model 15 without depending on a user notification. For example, the introduction determination unit 26 generates new teacher data in which the output result of the inspector model of which the matching rate is less than the threshold is set as correct answer information for the class 1 and relearns the machine learning model 15.

Note that, a timing of introduction determination can be arbitrarily set. For example, introduction determination can be performed at a timing when the matching rate is calculated by the deterioration detection unit 23, or introduction determination can be performed after calculation of the matching rate for equal to or more than a predetermined number of pieces of input data of the introduction destination is completed.

### Flow of Processing

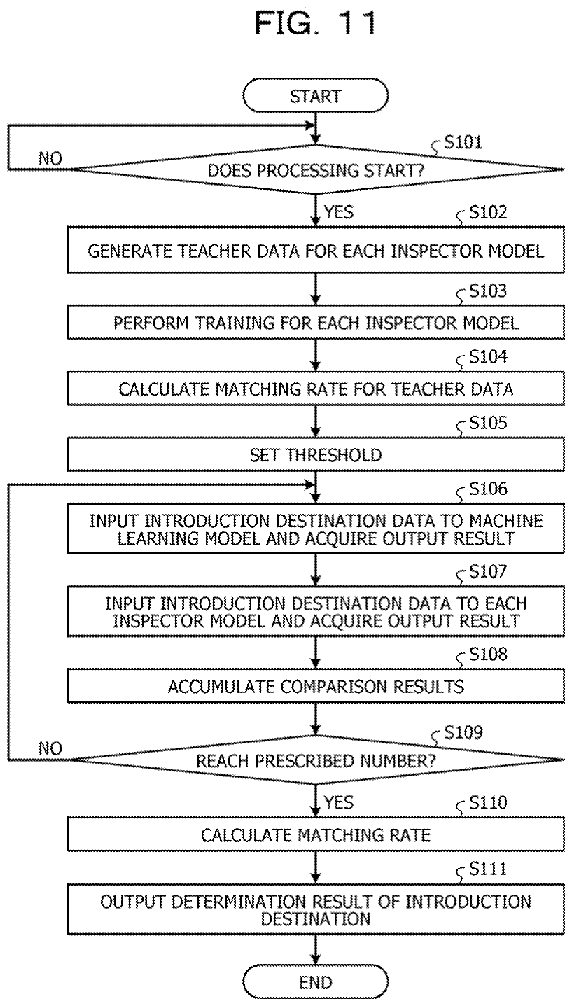

FIG. 11 is a flowchart illustrating a flow of processing. As illustrated in FIG. 11, when the processing is started (S101: Yes), the inspector model generation unit 21 generates teacher data for each inspector model on the basis of the teacher data under the development environment (S102) and performs training for each inspector model using training data in the generated teacher data under the development environment and generates each inspector model (S103).

Subsequently, the threshold setting unit 22 calculates a matching rate of an output result obtained by inputting verification data in the teacher data under the development environment to the machine learning model 15 and each inspector model (S104) and sets a threshold based on the matching rate (S105).

Thereafter, the deterioration detection unit 23 inputs the input data of the introduction destination to the machine learning model 15 and acquires an output result (S106) and inputs the input data of the introduction destination to each inspector model and acquires an output result (S107).

Then, the deterioration detection unit 23 accumulates comparison between the output results, for example, a distribution of the model applicability domain in the feature amount space (S108) and repeats S106 and subsequent processing until the number of accumulations reaches the prescribed number (S109: No).

Thereafter, when the number of accumulations reaches the prescribed number (S109: Yes), the deterioration detection unit 23 calculates the matching rate of each inspector model and the machine learning model 15 for each class (S110). Then, the introduction determination unit 26 determines whether or not the machine learning model 15 is introduced into the production environment on the basis of the matching rate and outputs a determination result to the determined introduction destination (S111).

### Effects

As described above, the introduction determination device 10 prepares a plurality of inspector models that solves a problem similar to the machine learning model to be inspected and calculates the matching rate of the outputs for each class or each inspector model. Then, the introduction determination device 10 inspects performance decrease of the machine learning model from a difference between the distribution of the matching rate under the development environment and that under the production environment and determines whether or not introduction can be performed. As a result, because the introduction determination device 10 can automatically inspect the model performance decrease in advance before the introduction and no manpower is needed, cost at the time when the machine learning model 15 is introduced into the production environment can be reduced.

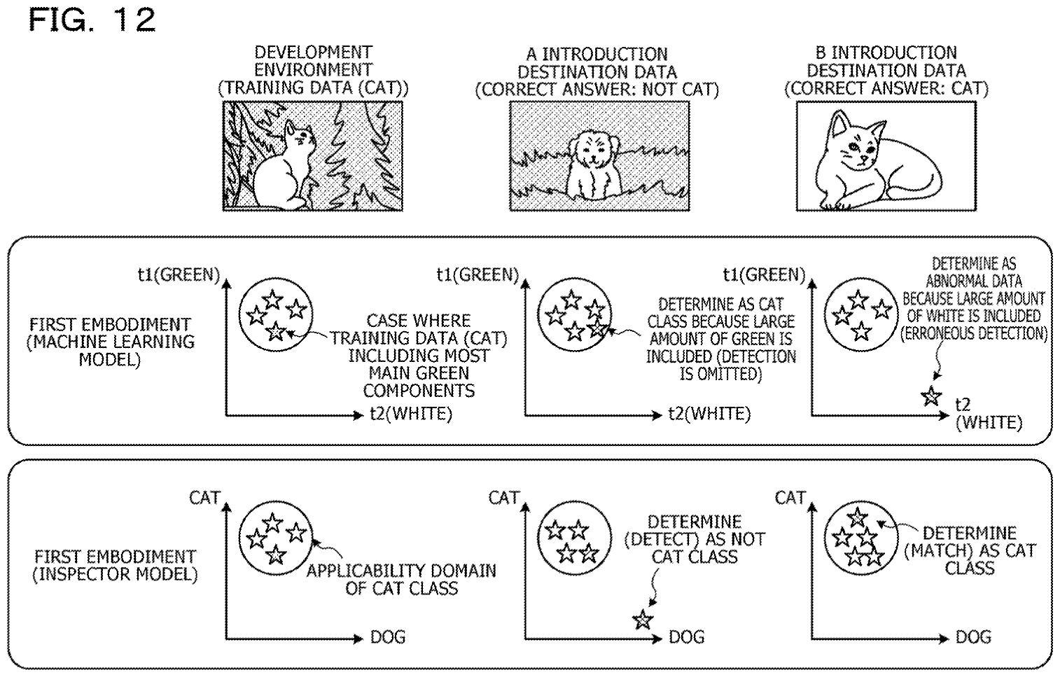

FIG. 12 is a diagram for explaining a specific example whether or not to perform introduction. The horizontal axis and the vertical axis of each graph in FIG. 12 indicate a feature amount. FIG. 12 illustrates an introduction determination result in a case where the machine learning model 15 learned using image data of a cat in which green is widely used for a background under the development environment as training data is introduced into an A introduction destination and a B introduction destination.

As illustrated in FIG. 12, the machine learning model 15 learns that many green components and many white components are included as a feature amount in order to determine the image data as a cat class at the time of development. Therefore, when image data of a dog having many green components is input as in the A introduction destination, the image data is erroneously determined as the cat class because the feature amount of the green component is learned as the cat class. Moreover, in a case of image data including an abnormally large amount of white as in the B introduction destination, because the white feature amount is too large even if the image data is a cat image, it is not possible for the machine learning model 15 to detect that the image data is the cat class.

On the other hand, the inspector model according to the first embodiment has a narrower model applicability domain than the machine learning model 15. Therefore, even when the image data of a dog having many green components is input as in the A introduction destination, the inspector model can determine that the image data is not the cat class. Moreover, even in a case of the image data of a cat including an abnormally large amount of white as in the B introduction destination, the feature amount of the cat can be accurately learned. Therefore, the inspector model can detect that the image data is the cat class.

As a result, when the input data of the A introduction destination is used, the matching rate of the output result of the machine learning model 15 and the output result of the inspector model decreases. Similarly, when the input data of the B introduction destination is used, the matching rate of the output result of the machine learning model 15 and the output result of the inspector model also decreases. Therefore, the introduction determination device 10 can determine that introduction into the A introduction destination and introduction into the B introduction destination are not appropriate.

Furthermore, based on these results, the introduction determination device 10 can relearn the machine learning model 15 using the image data of a dog having many green components (label: dog) or the image data of a cat including an abnormally large amount of white (label: cat). Furthermore, after relearning the machine learning model 15, a user can introduce the machine learning model 15 into the A introduction destination or the B introduction destination.

### Second Embodiment

By the way, in the first embodiment, an example has been described where the machine learning model 15 is evaluated using the data under the production environment. However, the present embodiment is not limited to this. For example, it is possible to develop a versatile machine learning model using data of a plurality of different customers.

For example, due to security and contract problems, it is assumed that it is difficult to use on-site data acquired from a customer as teacher data of a machine learning model of another company (difficult customer) and the machine learning model is forced to be trained using teacher data prepared for each customer. Therefore, it is often difficult to bring the on-site data of each customer together and use the data as the teacher data in order to develop a versatile machine learning model.

Therefore, under a situation where it is not possible to use existing data of various customers as the teacher data of the machine learning model to be developed when a versatile machine learning model to be introduced into different environments (different customers) is developed, the introduction determination device 10 according to the second embodiment inspects input data suitable for developing the versatile machine learning model and generates teacher data. Note that, processing to be described here can be executed independently from each processing described in the first embodiment.

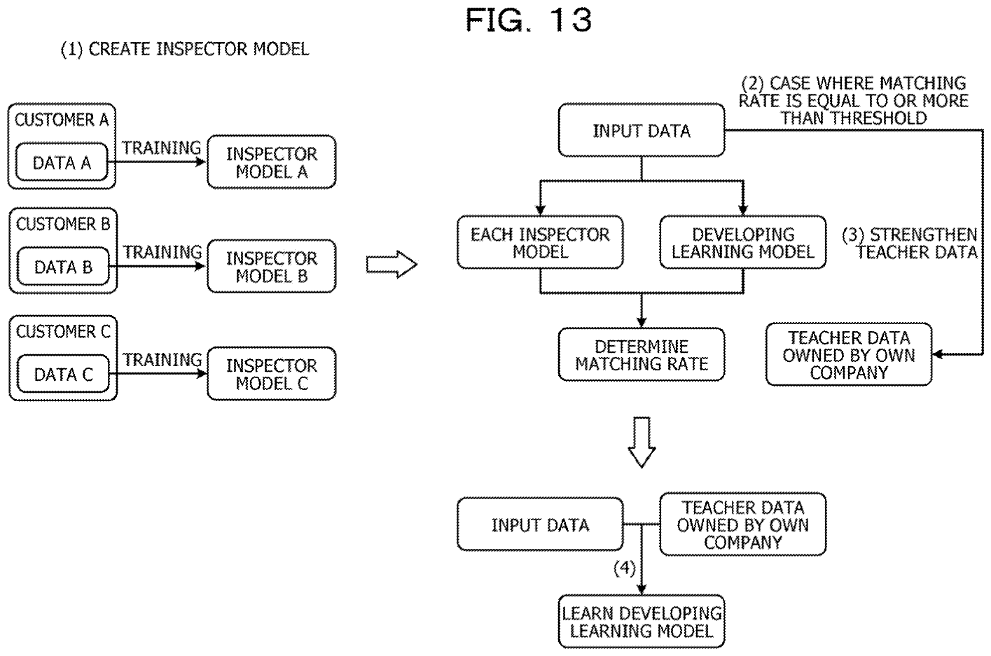

FIG. 13 is a diagram for explaining a method for generating the machine learning model 15 according to the second embodiment. As illustrated in FIG. 13, the introduction determination device 10 generates an inspector model for each customer using on-site teacher data of an existing customer (refer to (1) in FIG. 13). For example, the inspector model generation unit 21 generates an inspector model A using data (teacher data) of a customer A, generates an inspector model B using data (teacher data) of a customer B, and generates an inspector model C using data (teacher data) of a customer C.

Next, the introduction determination device 10 inputs each input data collected from the Internet or the like for each inspector model into each of a developing model (machine learning model 15) and the inspector model and calculates a matching rate (refer to (2) in FIG. 13).

For example, the deterioration detection unit 23 inputs input data X to the inspector model A, the inspector model B, the inspector model C, and the developing model and calculates a matching rate of the inspector model A and the developing model (0.6), a matching rate of the inspector model B and the developing model (0.2), and a matching rate of the inspector model C and the developing model (0.9).

Furthermore, the deterioration detection unit 23 inputs input data Y to the inspector model A, the inspector model B, the inspector model C, and the developing model, and calculates a matching rate of the inspector model A and the developing model (0.1), a matching rate of the inspector model B and the developing model (0.3), and a matching rate of the inspector model C and the developing model (0.2).

Then, the introduction determination device 10 adds input data of which the matching rate between the one inspector model and the developing learning model is equal to or more than a threshold to the teacher data (refer to (3) in FIG. 13). Describing the above example, regarding the input data X, because the matching rate with the inspector model A and the matching rate with the inspector model C are equal to or more than the threshold (0.6), the introduction determination unit 26 selects the input data X as the teacher data. On the other hand, regarding the input data Y, because the matching rates with all the inspector models are less than the threshold (0.6), the introduction determination unit 26 does not select the input data Y as the teacher data.

Thereafter, by relearning the developing learning model using all the pieces of added teacher data, the introduction determination device 10 can generate a more versatile learning model. Describing the above example, the introduction determination unit 26 adds the input data X among the input data collected from the Internet to a teacher data group under the development environment and relearns a developing learning model.

According to the processing described above, because it is possible to develop a versatile machine learning model using only teacher data owned by the own company, it is not necessary to newly develop a machine learning model for a new customer, and cost can be reduced.

### Third Embodiment

Incidentally, while the embodiments of the present disclosure have been described above, the present disclosure may be carried out in a variety of different modes in addition to the embodiments described above.

### Environment or the Like

In the embodiments described above, the production environment different from the development environment (learning environment) has been described as an example. However, as an example of the environment, a model usage scene, places of a camera or a sensor that generates teacher data, a system environment to which the model is applied, or the like are assumed.

### Relearning

In the embodiments described above, an example has been described where, when it is determined that the machine learning model 15 needs to be relearned, the machine learning model 15 is relearned using the relearning data using the determination result of the inspector model for the input data of the introduction destination as correct answer information. For example, an example has been described where, when a determination result of the inspector model for input data P of the introduction destination is “label P” and a determination result of the machine learning model is “label Q”, the machine learning model 15 is relearned using relearning data using the input data as an explanatory variable and the label P as an objective variable. However, the present embodiment is not limited to this.

For example, it is possible to collect data under the production environment that is the introduction destination and use the data as the relearning data. For example, the machine learning model 15 can be relearned using relearning data using each input data imaged by a real camera under the production environment as an explanatory variable and correct answer information (label) of each input data as an objective variable.

Furthermore, in the second embodiment, the machine learning model in the middle of the development has been described as an example. However, the second embodiment can be applied to a learned machine learning model, and in that case, the machine learning model is relearned. Furthermore, the input data used to determine the matching rate in the second embodiment may also be data of customers A, B, and C. In this case, data effective for general-purpose learning is extracted from among the data of each of the customers A, B, and C.

### Numerical Values, Etc.

Furthermore, the data example, the numerical values, each threshold, the feature amount space, the number of labels, the number of inspector models, the specific example, or the like used in the embodiments described above are merely examples and can be arbitrarily changed. Furthermore, the input data, the learning method, or the like are merely examples and can be arbitrarily changed. Furthermore, as the learning model, various methods such as a neural network can be adopted.

### Model Applicability Range or the Like

In the first embodiment, an example has been described where the plurality of inspector models having different model applicability ranges is generated by reducing the number of pieces of teacher data. However, the present embodiment is not limited to this, and for example, the plurality of inspector models having different model applicability ranges can be generated by reducing the number of times of training (the number of epochs). Furthermore, the plurality of inspector models having different model applicability ranges can be generated by reducing the number of pieces of training data included in the teacher data, not the number of pieces of teacher data.

### Matching Rate

For example, in the embodiments described above, an example has been described in which the matching rate of the input data belonging to the model applicability domain of each class is obtained. However, the embodiment is not limited to this. For example, accuracy deterioration can be detected according to the matching rate of the output result of the machine learning model 15 and the output result of the inspector model.

Furthermore, in the example in FIG. 9, although the matching rate is calculated as focusing on the class 0, it is possible to focus on each class. For example, in the example in FIG. 9, after the time elapses, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that three piece of input data belongs to the model applicability domain of the class 0, nine pieces of input data belongs to the model applicability domain of the class 1, and eight pieces of input data belongs to the model applicability domain of the class 2 from the inspector model. In this case, the monitoring unit 25 can detect the decrease in the matching rate for each of the class 0 and the class 1.

### System

Pieces of information including a processing procedure, a control procedure, a specific name, various types of data, and parameters described above or illustrated in the drawings may be optionally changed unless otherwise specified.

Furthermore, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part of the devices may be configured by being functionally or physically distributed or integrated in optional units depending on various types of loads, usage situations, or the like. For example, a device that executes the machine learning model 15 and classifies the input data and a device that detects accuracy deterioration can be implemented as different housings.

Moreover, all or any part of individual processing functions performed by each device may be implemented by a central processing unit (CPU) and a program analyzed and executed by the CPU or may be implemented as hardware by wired logic.

### Hardware

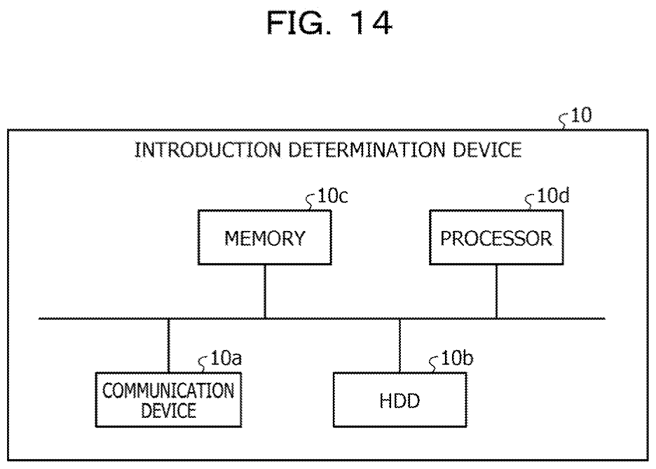

FIG. 14 is a diagram for explaining a hardware structure example. As illustrated in FIG. 14, the introduction determination device 10 includes a communication device 10a, a hard disk drive (HDD) 10b, a memory 10c, and a processor 10d. Furthermore, the respective units illustrated in FIG. 14 are mutually connected by a bus or the like.

The communication device 10a is a network interface card or the like and communicates with another device. The HDD 10b stores a program that operates the functions illustrated in FIG. 4, and a DB.

The processor 10d reads a program that executes processing similar to the processing of each processing unit illustrated in FIG. 4 from the HDD 10b or the like, and develops the read program in the memory 10c, thereby operating a process that executes each function described with reference to FIG. 4 or the like. For example, this process executes a function similar to the function of each processing unit included in the introduction determination device 10. Specifically, for example, the processor 10d reads a program having functions similar to those of the inspector model generation unit 21, the threshold setting unit 22, the deterioration detection unit 23, the introduction determination unit 26, or the like from the HDD 10b or the like. Then, the processor 10d executes a process for executing processing similar to those of the inspector model generation unit 21, the threshold setting unit 22, the deterioration detection unit 23, the introduction determination unit 26, or the like.

As described above, the introduction determination device 10 operates as an information processing device that executes the introduction determination method by reading and executing the programs. Furthermore, the introduction determination device 10 may also implement functions similar to the functions of the above-described embodiments by reading the program described above from a recording medium by a medium reading device and executing the read program described above. Note that the program referred to in other embodiments is not limited to being executed by the introduction determination device 10. For example, the embodiment may be similarly applied to a case where another computer or server executes the program, or a case where these computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A determination method performed by a computer, the determination method comprising:
acquiring a first output result when data generated under second environment different from a first environment that is a training environment is input to a trained model;
acquiring a second output result when the data is input to a detection model that detects decrease in a correct answer rate of a trained model when the trained model is converted into the second environment; and
determining whether or not to retrain the trained model when the trained model is converted into the second environment based on the first output result and the second output result.

2. The determination method according to claim 1 further comprising:
retraining the trained model by using retraining data by using the data as an explanatory variable and a determination result as an objective variable based on the determination result of the detection model for the data when it is determined to relearn the trained model.

3. The determination method according to claim 1, further comprising:
retraining the trained model by using data generated under the another environment in a case where it is determined to retrain the trained model.

4. The determination method according to claim 1, further comprising:
generating a plurality of detection models that respectively corresponds to a plurality of environments by using teacher data of each of the plurality of environments;
calculating a matching rate of an output result of the trained model in the middle of training and an output result of each of the plurality of detection models by inputting each of a plurality of pieces of data into the trained model in the middle of training and each of the plurality of detection models; and
selecting data of which one matching rate that corresponds to the plurality of detection models is equal to or more than a threshold from among the plurality of pieces of data, as training data of the trained model.

5. The determination method according to claim 4, further comprising:
learning the trained model by using teacher data generated under the first environment and the training data.

6. A non-transitory computer-readable storage medium storing a determination program that causes a processor included in a computer to execute a process, the process comprising:
acquiring a first output result when data generated under second environment different from a first environment that is a training environment is input to a trained model;
acquiring a second output result when the data is input to a detection model that detects decrease in a correct answer rate of a trained model when the trained model is converted into the second environment; and
determining whether or not to retrain the trained model when the trained model is converted into the second environment based on the first output result and the second output result.

7. An information processing device comprising:
a memory; and
a processor coupled to the memory and configured to:
acquire a first output result when data generated under second environment different from a first environment that is a training environment is input to a trained model,
acquire a second output result when the data is input to a detection model that detects decrease in a correct answer rate of a trained model when the trained model is converted into the second environment, and
determine whether or not to retrain the trained model when the trained model is converted into the second environment based on the first output result and the second output result.
